(19) United States
(12) Patent Application Publication
(10) Pub. No.: US 2025/0207988 A1
(43) Pub. Date: Jun. 26, 2025

(54) MAGNETOSTRICTIVE TORQUE SENSOR

(71) Applicant: Proterial, Ltd., Tokyo (JP)

(72) Inventor: Akitoshi FUJIMORI, Tokyo (JP)

(73) Assignee: Proterial, Ltd., Tokyo (JP)

(21) Appl. No.: 18/912,012

(22) Filed: Oct. 10, 2024

(30) Foreign Application Priority Data
Dec. 21, 2023 (JP) 2023-215529

(51) Int. Cl. G01L 3/10

(52) U.S. Cl. CPC G01L 3/102

(57) ABSTRACT

A magnetostrictive torque sensor is configured to be attached around a rotating shaft exhibiting a magnetostrictive effect and detects torque transmitted by the rotating shaft, and includes a holder having a cylinder portion with a hollow cavity in a center through which the rotating shaft is inserted and a protrusion provided to protrude radially outward from the cylinder portion, and a flexible substrate that includes a detection portion on which a coil group including a combination of a plurality of detection coils aligned in a predetermined direction is formed by a wiring pattern, and a signal line portion on which a plurality of signal lines electrically connecting the coil group to an external device are formed by a wiring pattern, wherein the detection portion is wrapped around an outer circumference of the cylinder portion of the holder, and wherein a part in a longitudinal direction of the signal line portion is fixed to the protrusion of the holder by a fixing member, and a tip end-side portion of the signal line portion than the fixed portion is led out of the holder.

### CROSS-REFERENCE TO RELATED APPLICATIONS

The present application is based on Japanese patent application No. 2023-215529 filed on Dec. 21, 2023, the entire contents of which are incorporated herein by reference.

### TECHNICAL FIELD

The present invention relates to a magnetostrictive torque sensor to detect torque transmitted by a rotating shaft exhibiting a magnetostrictive effect.

### BACKGROUND OF THE INVENTION

Conventionally, magnetostrictive torque sensors are used to detect torque of, e.g., an output rotating shaft of an automobile engine, etc. Magnetostrictive torque sensors are configured to detect torque applied to a rotating shaft based on changes in the inductance of a detection coil placed around the rotating shaft, using the magnetostrictive effect in which the magnetic permeability of the rotating shaft changes due to stress. The present applicant has proposed a magnetostrictive torque sensor that has a flexible substrate having plural detection coils formed thereon and placed around a rotating shaft and detects torque applied to the rotating shaft based on changes in the inductances of the plural detection coils (see Patent Literature 1).

In the magnetostrictive torque sensor described in Patent Literature 1, the flexible substrate having plural detection coils is housed in a resin housing. Plural terminals are provided at an end of the flexible substrate, and signal lines of a cable are connected to these terminals inside the resin housing. The cable is led out of the resin housing and is connected to a control device.
Citation List Patent Literature 1: JP2022-74405A

### SUMMARY OF THE INVENTION

It is sometimes difficult to secure installation spaces of torque sensors around rotating shafts, and there is a demand for reducing the size of torque sensors. The invention was made in response to this demand, and it is an object of the invention to provide a magnetostrictive torque sensor that can be reduced in size.

To achieve the object described above, one aspect of the invention provides a magnetostrictive torque sensor configured to be attached around a rotating shaft exhibiting a magnetostrictive effect and detects torque transmitted by the rotating shaft, comprising:
a holder comprising a cylinder portion with a hollow cavity in a center through which the rotating shaft is inserted and a protrusion provided to protrude radially outward from the cylinder portion; and
a flexible substrate that comprises a detection portion on which a coil group comprising a combination of a plurality of detection coils aligned in a predetermined direction is formed by a wiring pattern, and a signal line portion on which a plurality of signal lines electrically connecting the coil group to an external device are formed by a wiring pattern,
wherein the detection portion is wrapped around an outer circumference of the cylinder portion of the holder, and
wherein a part in a longitudinal direction of the signal line portion is fixed to the protrusion of the holder by a fixing member, and a tip end-side portion of the signal line portion than the fixed portion is led out of the holder.

### Advantageous Effects of the Invention

According to the invention, it is possible to reduce the size of the magnetostrictive torque sensor, allowing for installation space saving.

### BRIEF DESCRIPTION OF DRAWINGS

FIG. 1 is a perspective view showing a magnetostrictive torque sensor in the first embodiment, which is shown together with a rotating shaft to be subjected to detection.

FIG. 2 is an exploded perspective view showing the magnetostrictive torque sensor.

FIG. 3 is an exploded perspective view showing the magnetostrictive torque sensor when viewed in a direction different from in FIG. 2.

FIG. 4 is a cross-sectional view showing the magnetostrictive torque sensor.

FIG. 5A is a plan view showing one flexible substrate.

FIG. 5B is a plan view showing a base material from which plural flexible substrates are cut out.

FIG. 6 is a cross-sectional view showing a layer structure of the flexible substrate.

FIGS. 7A to 7D are plan views showing first to fourth wiring layers.

FIG. 8 is a schematic circuit diagram illustrating a configuration example of an electric circuit composed of a flexible substrate, an oscillator, and a voltmeter.

FIGS. 9A and 9B are perspective views in which a holder and a cover member are viewed from different directions.

FIGS. 10A to 10C are perspective views of the cover member.

FIG. 11A is a configuration diagram showing a peripheral portion around a protrusion of a holder together with the cover member and a part of the flexible substrate.

FIG. 11B is a configuration diagram showing a peripheral portion around the protrusion of the holder and a part of the flexible substrate with which the cover member is not assembled.

FIG. 12A is a cross-sectional view of the holder, the cover member, the flexible substrate, and an adhesive taken along line A-A in FIG. 11A.

FIG. 12B is an enlarged view of a B-section in FIG. 12A.

FIG. 13A is a cross-sectional view of the holder, the cover member, the flexible substrate, and the adhesive in a cross-section perpendicular to an axial direction.

FIG. 13B is an enlarged view of a C-section in FIG. 13A.

FIG. 14 is a partially enlarged view of the holder, the cover member, the flexible substrate, and an adhesive as viewed from an arrow D-direction in FIG. 11A.

FIG. 15 is an exploded perspective view of a magnetostrictive torque sensor in the second embodiment.

FIG. 16A is a partial cross-sectional view of the magnetostrictive torque sensor in the second embodiment.

FIG. 16B is an enlarged view of an E-section in FIG. 16A.

FIG. 17 is an enlarged view of the magnetostrictive torque sensor in the second embodiment as viewed from an arrow F-direction in FIG. 16A.

### DETAILED DESCRIPTION OF THE INVENTION

### First Embodiment

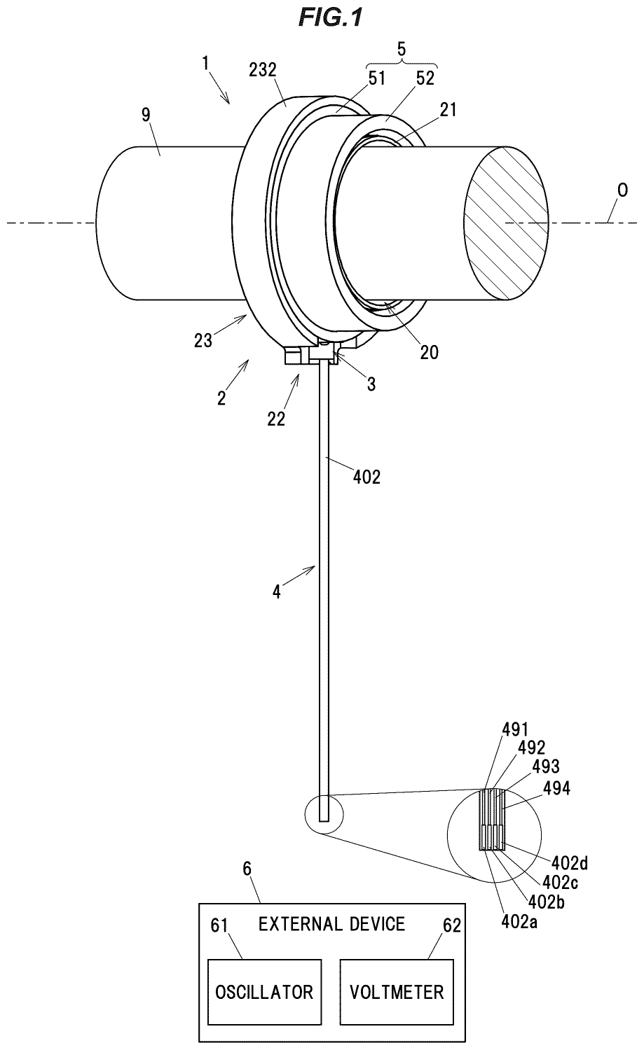

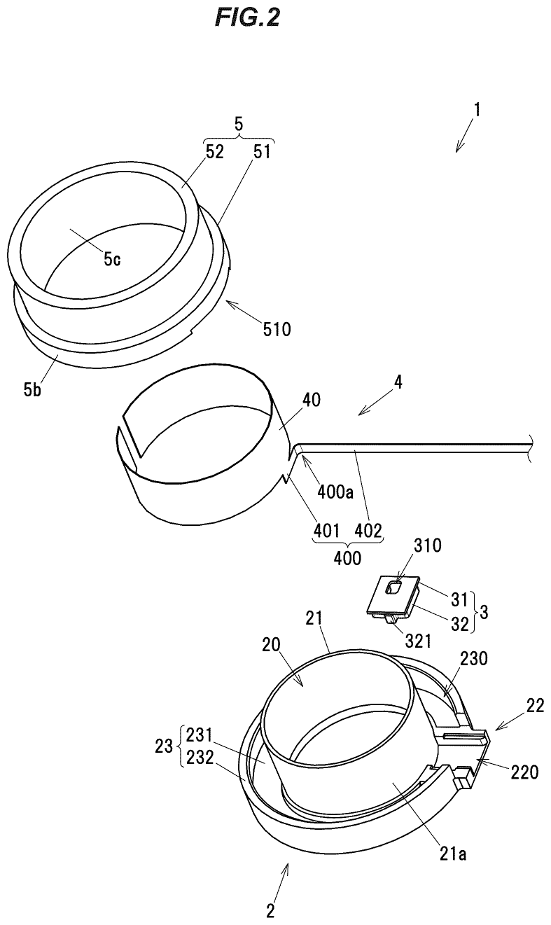

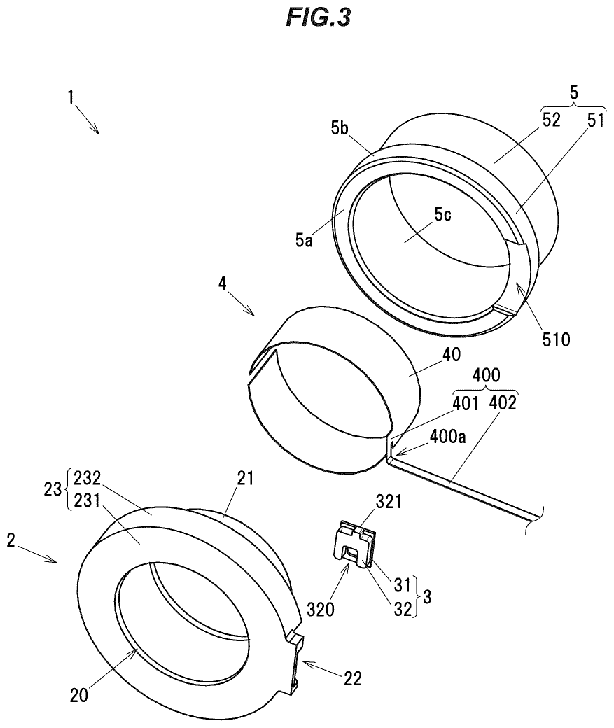

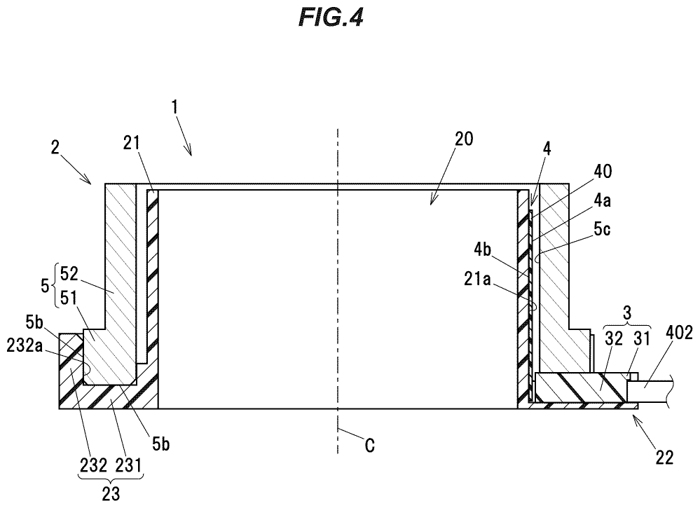

FIG. 1 is a perspective view showing a magnetostrictive torque sensor 1 in an embodiment of the invention, which is shown together with a rotating shaft 9 to be subjected to detection. FIG. 2 is an exploded perspective view showing the magnetostrictive torque sensor 1. FIG. 3 is an exploded perspective view showing the magnetostrictive torque sensor 1 when viewed in a direction different from in FIG. 2. FIG. 4 is a cross-sectional view showing the magnetostrictive torque sensor 1.

The magnetostrictive torque sensor 1 is attached around the rotating shaft 9 and detects torque transmitted by the rotating shaft 9. The rotating shaft 9 is, e.g., a shaft that transmits a driving force of a drive source such as an automobile engine or electric motor. The torque detection result obtained by the magnetostrictive torque sensor 1 is used to control the drive source or an automatic transmission, etc.

The rotating shaft 9 is a ferromagnetic material exhibiting a magnetostrictive effect, and rotates around a rotation axis O to transmit torque. Here, the magnetostrictive effect is a phenomenon in which the shape of a ferromagnetic material is distorted when the ferromagnetic material is magnetized by applying a magnetic field. By using this phenomenon in an opposite manner and detecting changes in magnetic properties caused by distortion of the shape, it is possible to detect torque applied to the rotating shaft 9. It is possible to suitably use the rotating shaft 9 obtained by, e.g., carburizing, quenching and tempering a shaft-shaped body made of chrome steel containing chrome, such as a chrome steel, a chrome-molybdenum steel or a nickel-chrome molybdenum steel, and further performing shot peening.

The magnetostrictive torque sensor 1 has a holder 2, a cover member 3, a flexible substrate 4, a magnetic ring 5 made of a soft magnetic material, and an external device 6 arranged outside the holder 2. The external device 6 has an oscillator 61 and a voltmeter 62 and is electrically connected to the flexible substrate 4. The operation of the external device 6 will be described later.

The holder 2 is made of, e.g., a resin material such as PPS (polyphenylene sulfide) and is injection molded. The holder 2 has the cylinder portion 21 with a hollow cavity 20 in the center through which the rotating shaft 9 is inserted, a protrusion 22 provided to protrude radially outward from the cylinder portion 21, and a magnetic ring holder 23 that holds the magnetic ring 5 between the cylinder portion 21 and itself. The protrusion 22 protrudes from a circumferential portion of the cylinder portion 21 along a direction perpendicular to an outer circumferential surface 21a of the cylinder portion 21. The magnetic ring holder 23 has a peripheral wall 231 facing an one axial end surface 5a of the magnetic ring 5 and a rim wall 232 facing an outer circumferential surface 5b of the one axial end of the magnetic ring 5. The rim wall 232 is arcuate except for the portion where the protrusion 22 is provided.

Between an inner circumferential surface 232a of the rim wall 232 and the outer circumferential surface 21a of the cylinder portion 21, an annular groove 230 is formed to accommodate the one axial end of the magnetic ring 5. A recessed portion 220 is formed at the protrusion 22 to accommodate a part of the flexible substrate 4. The holder 2 is positioned in such a manner that a central axis C of the cylinder portion 21 is aligned with a rotation axis O of the rotating shaft 9. Hereinafter, a direction parallel to the central axis C of the cylinder portion 21 is called an axial direction. The annular groove 230 and the recessed portion 220 are recessed axially.

The cover member 3 is made of, e.g., the same resin material as the holder 2 and is formed by injection-molding. The cover member 3 integrally has a plate portion 31 covering the one axial end side of the recessed portion 220 formed at the protrusion 22, and a boss 32 that mates with the recessed portion 220. The details of the shapes of the cover member 3 and the recessed portion 220 will be described later.

The magnetic ring 5 is made of, e.g., steel or a sintered magnetic material, has soft magnetic properties, and is formed in a cylindrical shape with an inner diameter larger than an outer diameter of the cylinder portion 21 of the holder 2. When the magnetic ring 5 is made of steel, a magnetic steel material such as electromagnetic stainless steel can be suitably used and, e.g., deep drawing can be used as the forming method. Alternatively, the magnetic ring 5 may be formed by cutting a long pipe-shaped steel material to a predetermined length. The magnetic ring 5 is fixed to the holder 2 by, e.g., adhesive bonding. The magnetic ring 5 is aligned with the cover member 3 in the axial direction and restricts movement of the cover member 3 in a direction in which the boss 32 separates away from the recessed portion 220 of the holder 2.

In the present embodiment, the magnetic ring 5 integrally has a large diameter portion 51 and a small diameter portion 52 which have different outer diameters. An inner diameter of the large diameter portion 51 and an inner diameter of the small diameter portion 52 are the same. The large diameter portion 51 is provided at the one axial end of the magnetic ring 5 and is housed in the annular groove 230 of the holder 2. By fitting the large diameter portion 51 into the annular groove 230 in a spigot and socket manner, the magnetic ring 5 is positioned relative to the holder 2. In more particular, by contact of the outer circumferential surface 5b of the magnetic ring 5 at the large diameter portion 51 with the inner circumferential surface 232a of the rim wall 232, the magnetic ring 5 is positioned relative to the holder 2 in the radial direction perpendicular to the axial direction.

As shown in FIG. 3, on the one axial end surface 5a of the magnetic ring 5, a notch 510 recessed from the end surface 5a in the axial direction is formed on a portion facing the plate portion 31 of the cover member 3. When the cover member 3 and the magnetic ring 5 are assembled to the holder 2, a portion of the plate portion 31 of the cover member 3 is housed in the notch 510 and the one axial end surface 5a of the magnetic ring 5 is in contact with the rim wall 231 of the magnetic ring holder 23 of the holder 2.

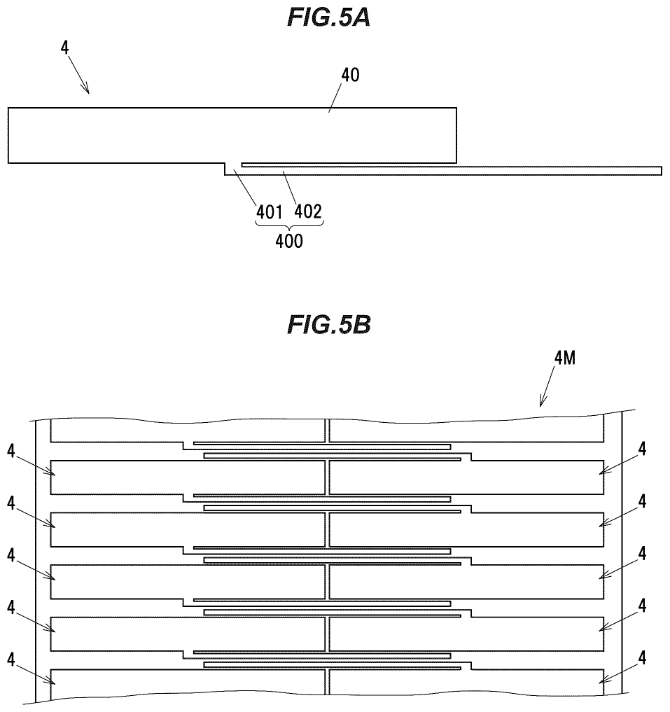

FIG. 5A is a plan view showing one flexible substrate 4. FIG. 5B is a plan view showing a base material 4M from which plural flexible substrates 4 are cut out. The flexible substrate 4 is manufactured by cutting the base material 4M.

The flexible substrate 4 integrally has a detection portion 40 having plural detection coils to detect a magnetic field of the rotating shaft 9, and a signal line portion 400 on which plural signal lines electrically connecting the external device 6 to the detection portion 40 are formed by a wiring pattern. The plural detection coils and the plural signal lines are not shown in FIGS. 5A and 5B. The flexible substrate 4 is arranged in such a manner that the detection portion 40 is wrapped around the outer circumference of the cylinder portion 21 of the holder 2 and held by the holder 2, and a portion of the signal line portion 400 is led out of the holder 2. On the detection portion 40, coil groups each composed of a combination of the plural detection coils aligned in a predetermined direction are formed by wiring patterns. The detection portion 40 has a rectangular shape with a long-side direction coincident with an alignment direction of the plural detection coils.

The signal line portion 400 is partially fixed to the protrusion 22 of the holder 2 longitudinally by a fixing member to be described below, and its tip end side is led out of the holder 2 from a portion fixed to the protrusion 22 of the holder 2. The signal line portion 400 has a protruding piece 401 protruding perpendicular to a long side direction from the detection portion 40 and a linear portion 402 extending from the protruding piece 401 in the long side direction of the detection portion 40. This shape of the flexible substrate 4 allows plural flexible substrates 4 to be cut out of the base material 4M with a reduced wasted area as shown in FIG. 5B, which can improve the yield. A length of the linear portion 402 is, e.g., 50 mm or more and 100 mm or less.

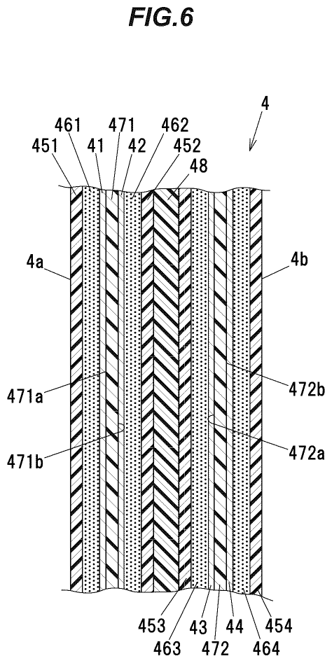

The protruding piece 401 protrudes from the center of the detection portion 40 in the long side direction toward a direction perpendicular to the long side direction of the detection portion 40. A portion of the linear portion 402, excluding a base end portion near the protruding piece 401 of both longitudinal ends and including a tip portion that is an end opposite to the base end portion, is led out of the holder 2. The recessed portion 220 of the holder 2 accommodates a part of the protruding piece 401 and the linear portion 402. First to fourth electrodes 402a to 402d are formed at the tip portion of the linear portion 402, as shown enlarged in FIG. 1. The linear portion 402 of the flexible substrate 4 may be directly connected to the external device 6, or may be connected to the external device 6 through a cable having plural electric wires. Next, an example configuration of the detection portion 40 will be described in detail with reference to FIGS. 6 to 8.

FIG. 6 is a cross-sectional view showing a layer structure of the flexible substrate 4. The flexible substrate 4 has a multilayer structure which has first to fourth wiring layers 41 to 44 and in which a coverlay film 451, an adhesive layer 461, the first wiring layer 41, a first base film 471, the second wiring layer 42, an adhesive layer 462, a coverlay film 452, a double-sided tape 48, a coverlay film 453, an adhesive layer 463, the third wiring layer 43, a second base film 472, the fourth wiring layer 44, an adhesive layer 464 and a coverlay film 454 are stacked in this order from one surface 4a, which is located on the outer side of the curve when wrapped around the outer circumference of the cylinder portion 21, to the other surface 4b on the inner side of the curve.

The first wiring layer 41 and the second wiring layer 42 are wiring patterns formed by etching copper foil and are respectively formed on a front surface 471a and a back surface 471b of the first base film 471. Likewise, the third wiring layer 43 and the fourth wiring layer 44 are wiring patterns formed by etching copper foil and are respectively formed on a front surface 472a and a back surface 472b of the second base film 472. The coverlay films 451, 452, 453, 454 are protective films adhered to the first to fourth wiring layers 41 to 44 by the adhesive layers 461, 462, 463, 464. The first and second base films 471, 472 and the coverlay films 451, 452, 453, 454 are made of an insulating resin such as polyimide.

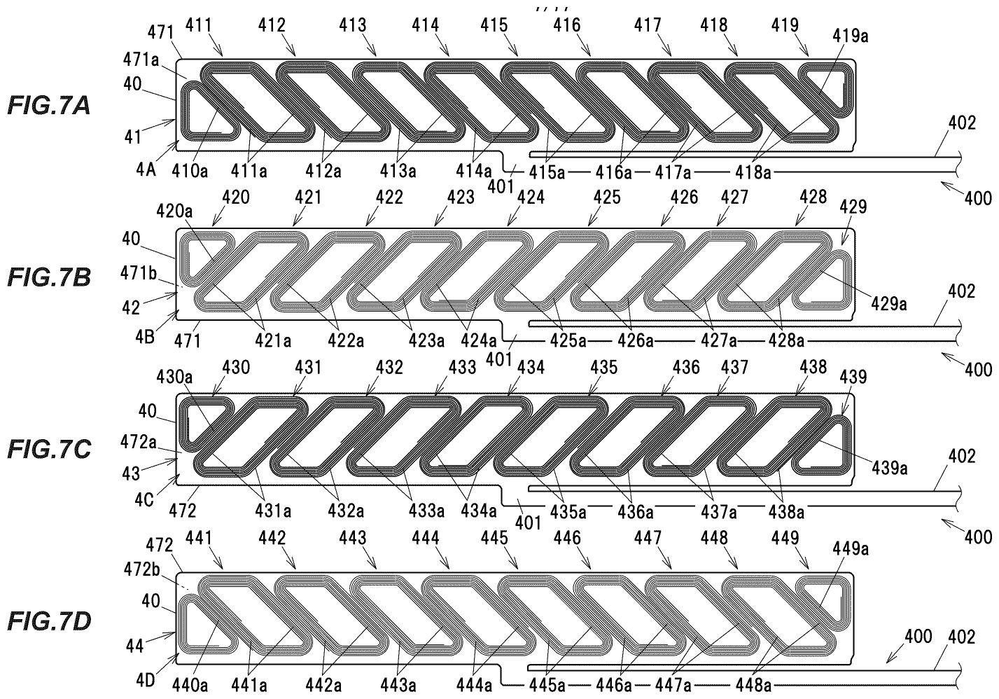

FIG. 7A is a plan view showing a wiring pattern of the first wiring layer 41 formed on the front surface 471a of the first base film 471. FIG. 7B is a plan view showing a wiring pattern of the second wiring layer 42 when viewed from the front surface 471a side of the first base film 471. FIG. 7C is a plan view showing a wiring pattern of the third wiring layer 43 formed on the front surface 472a of the second base film 472. FIG. 7D is a plan view showing a wiring pattern of the fourth wiring layer 44 when viewed from the front surface 472a side of the second base film 472.

On the first wiring layer 41, first to tenth detection coils 410 to 419 aligned in the long-side direction of the detection portion 40 are formed by a wiring pattern. The first and tenth detection coils 410 and 419 have a triangular shape, and the second to ninth detection coils 411 to 418 have a parallelogram shape. Likewise, on the second wiring layer 42, first to tenth detection coils 420 to 429 aligned in the long-side direction of the detection portion 40 are formed by a wiring pattern. The first and tenth detection coils 420 and 429 have a triangular shape, and the second to ninth detection coils 421 to 428 have a parallelogram shape.

On the third wiring layer 43, first to tenth detection coils 430 to 439 aligned in the long-side direction of the detection portion 40 are formed by a wiring pattern. The first and tenth detection coils 430 and 439 have a triangular shape, and the second to ninth detection coils 431 to 438 have a parallelogram shape. Likewise, on the fourth wiring layer 44, first to tenth detection coils 440 to 449 aligned in the long-side direction of the detection portion 40 are formed by a wiring pattern. The first and tenth detection coils 440 and 449 have a triangular shape, and the second to ninth detection coils 441 to 448 have a parallelogram shape.

The first to tenth detection coils 410 to 419 of the first wiring layer 41 and the first to tenth detection coils 440 to 449 of the fourth wiring layer 44 respectively have straight portions 410a to 419a and 440a to 449a which are inclined toward one side at a predetermined angle (+45°) relative to a short-side direction of the detection portion 40. The first to tenth detection coils 420 to 429 of the second wiring layer 42 and the first to tenth detection coils 430 to 439 of the third wiring layer 43 have respectively straight portions 420a to 429a and 430a to 439a which are inclined toward the other side at the predetermined angle (−45°) relative to the short-side direction of the detection portion 40.

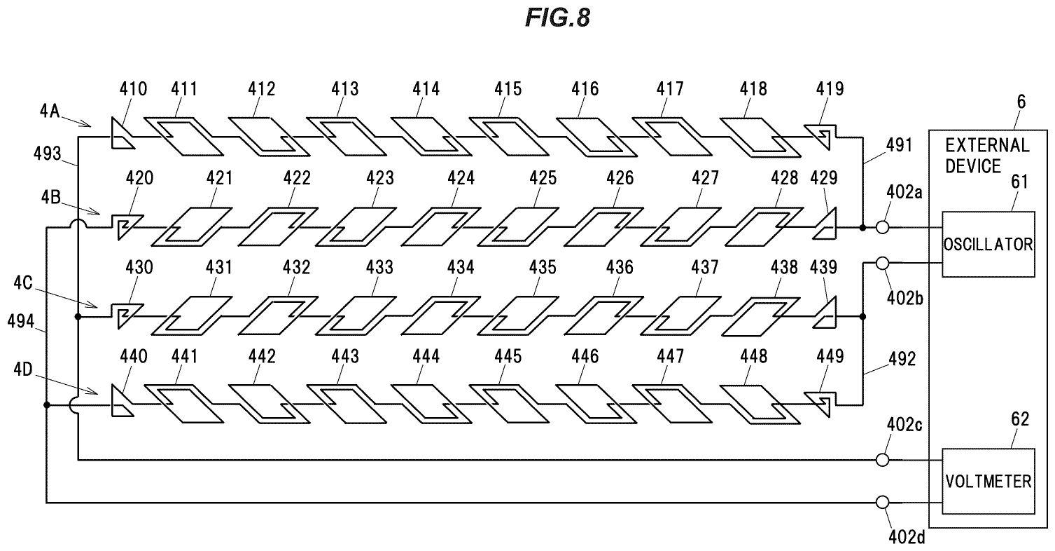

FIG. 8 is a schematic circuit diagram illustrating a configuration example of an electric circuit composed of the flexible substrate 4, the oscillator 61 and the voltmeter 62. The first to tenth detection coils 410 to 419 of the first wiring layer 41 are connected in series to form a first coil group 4A, and the first to tenth detection coils 420 to 429 of the second wiring layer 42 are connected in series to form a second coil group 4B. Likewise, the first to tenth detection coils 430 to 439 of the third wiring layer 43 are connected in series to form a third coil group 4C, and the first to tenth detection coils 440 to 449 of the fourth wiring layer 44 are connected in series to form a fourth coil group 4D.

The first coil group 4A and the third coil group 4C, and the second coil group 4B and the fourth coil group 4D, are connected respectively in series between the first electrode 402a and the second electrode 402b. One end of the first coil group 4A and one end of the second coil group 4B are connected to the first electrode 402a by a first signal line 491. One end of the third coil group 4C and one end of the fourth coil group 4D are connected to the second electrode 402b by a second signal line 492.

A third signal line 493, which connects the other end of the first coil group 4A and the other end of the third coil group 4C in series, is connected to the third electrode 402c. A fourth signal line 494, which connects the other end of the second coil group 4B and the other end of the fourth coil group 4D in series, is connected to the fourth electrode 402d. The first to fourth signal lines 491 to 494 are formed by a wiring pattern on the signal line portion 400. The oscillator 61 applies an AC voltage between the first electrode 402a and the second electrode 402b. The voltmeter 62 measures a voltage between the third electrode 402c and the fourth electrode 402d.

When torque is applied to the rotating shaft 9, magnetic permeability in the direction at +45 degrees from the axial direction decreases (or increases) and magnetic permeability in the direction at −45 degrees from the axial direction increases (or decreases). Therefore, when torque is applied to the rotating shaft 9 in a state in which AC voltage is applied from the oscillator 61, inductances of the first coil group 4A and the fourth coil group 4D decrease (or increase) and inductances of the second coil group 4B and the third coil group 4C increase (or decrease). Since this results in a change in the voltage measured by the voltmeter 62, the torque applied to the rotating shaft 9 can be detected based on this change in voltage.

Note that FIGS. 7A to 7D do not show wiring patterns of portions connecting in series between the first to tenth detection coils 410 to 419, 420 to 429, 430 to 439 and 440 to 449 of the first to fourth wiring layers 41 to 44, and wiring patterns constituting the first to fourth signal lines 491 to 494.

The other surface 4b of the detection portion 40 is adhered to the outer circumferential surface 21a of the cylinder portion 21 of the holder 2 with an adhesive. Both ends of the long side direction of the detection portion 40 may be fixed to the outer circumferential surface 21a of the cylinder portion 21 by an adhesive tape. The magnetic ring 5 is arranged so as to surround an outer circumference of the detection portion 40 to face the one surface 4a of the flexible substrate 4. The magnetic ring 5 increases the magnetic flux linking with each of the detection coils 410 to 419, 420 to 429, 430 to 439 and 440 to 449, thereby increasing the sensitivity of the magnetostrictive torque sensor 1. A space is formed between the one surface 4a of the detection portion 40 and an inner circumferential surface 5c of the magnetic ring 5, so that the flexible substrate 4 and the magnetic ring 5 are not in contact with each other.

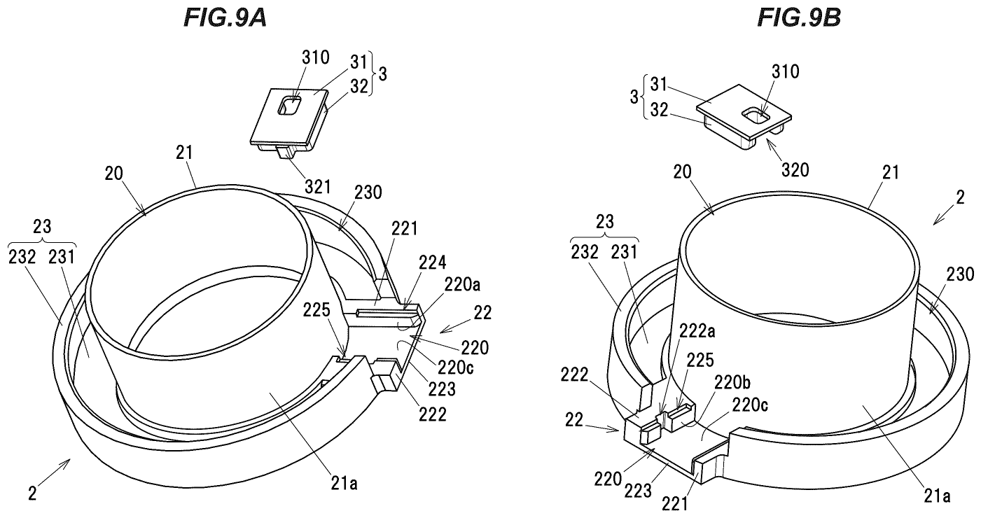

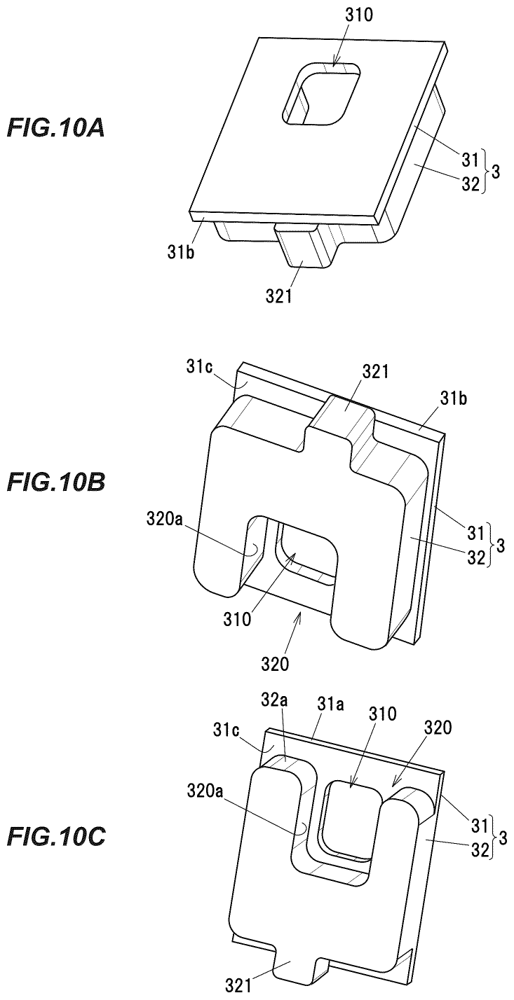

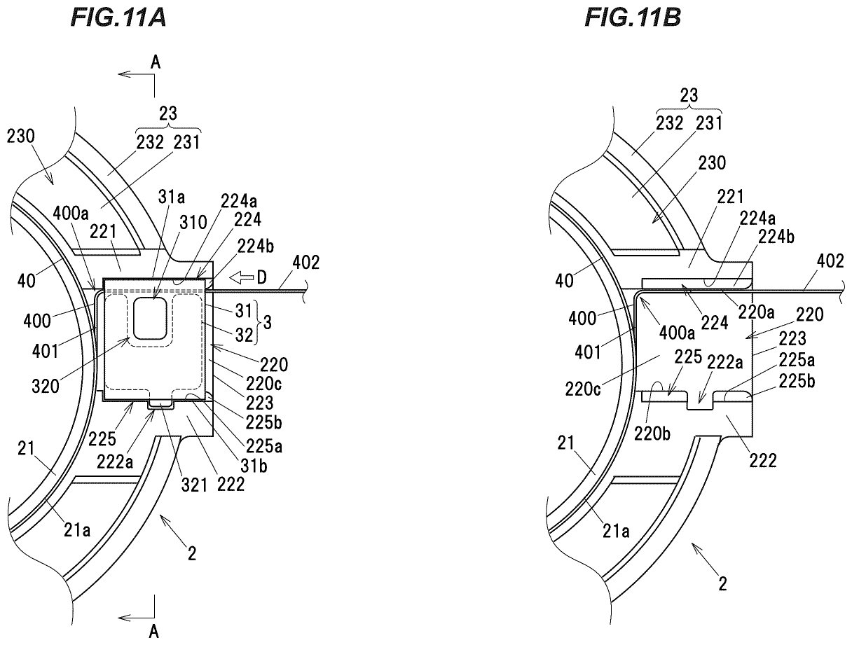

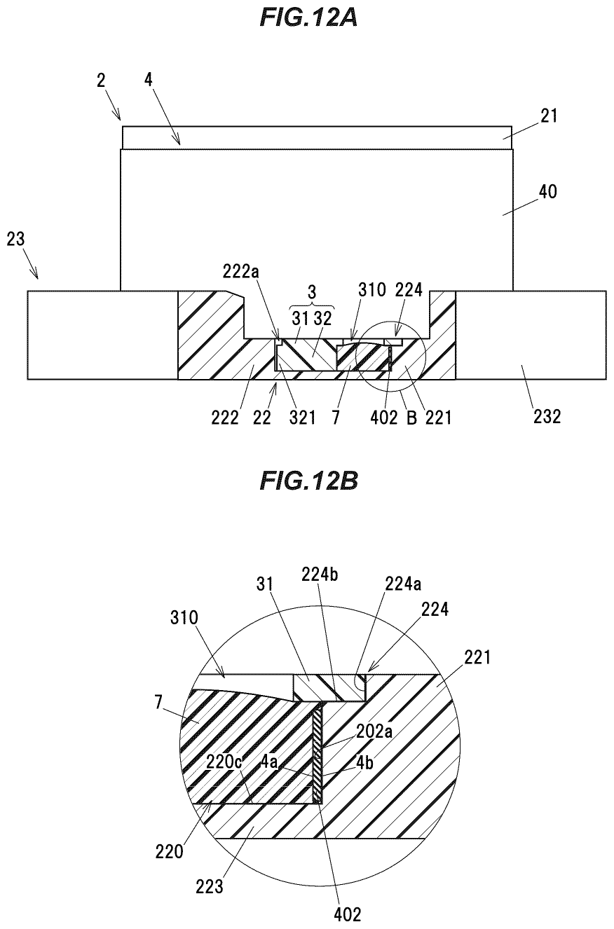

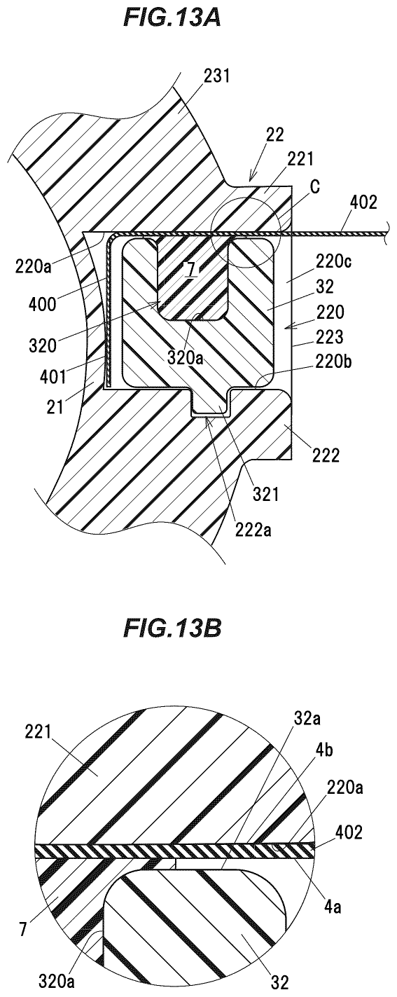

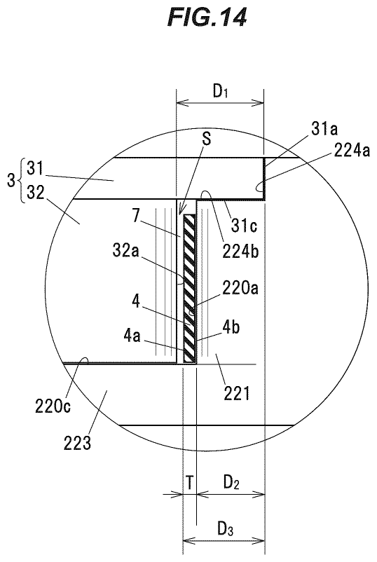

Next, the configuration of the protrusion 22 of the holder 2 and its surroundings is described with reference to FIGS. 9A to 14. The adhesive 7 as a fixing material is used to partially fix the longitudinal direction of the linear portion 402 in the signal line portion 400 of the flexible substrate 4 to the protrusion 22 of the holder 2. FIGS. 9A and 9B are perspective views in which a holder 2 and a cover member 3 are viewed from different directions. FIGS. 10A to 10C are perspective views of the cover member 3. FIG. 11A is a configuration diagram showing a peripheral portion around the protrusion 22 of the holder 2 together with the cover member 3 and a part of the flexible substrate 4. FIG. 11B is a configuration diagram showing a peripheral portion around the protrusion 22 of the holder 2 and a part of the flexible substrate 4 with which the cover member 3 is not assembled. FIG. 12A is a cross-sectional view of the holder 2, the cover member 3, the flexible substrate 4, and an adhesive 7 taken along line A-A in FIG. 11A. FIG. 12B is an enlarged view of a B-section in FIG. 12A. FIG. 13A is a cross-sectional view of the holder 2, the cover member 3, the flexible substrate 4, and the adhesive 7 in a cross-section perpendicular to an axial direction. FIG. 13B is an enlarged view of a C-section in FIG. 13A. FIG. 14 is a partially enlarged view of the holder 2, the cover member 3, the flexible substrate 4, and an adhesive 7 as viewed from an arrow D-direction in FIG. 11A.

The protrusion 22 has a pair of side wall portions 221, 222 lined up in the circumferential direction of the cylinder portion 21 with the recessed portion 220 in between, and a bottom wall portion 223 forming a bottom surface 220c of the recessed portion 220. The pair of side wall portions 221, 222 protrude axially from the bottom wall portion 223 to form inner wall surfaces 220a, 220b of the recessed portion 220. One side wall portion 221 of the pair of side wall portions 221, 222 is referred to as the first side wall portion 221 and the other side wall portion 222 as the second side wall portion 222. Of the inner wall surfaces 220a, 220b, the inner wall surface 220a of the first side wall portion 221 is referred to as the first inner wall surface 220a, and the inner wall surface 220b of the second side wall portion 222 is referred to as the second inner wall surface 220b. The inner wall portions 220a, 220b are parallel and facing each other across the recessed portion 220.

The linear portion 402 in the signal line portion 400 of the flexible substrate 4 is bent inside the recessed portion 220 and is led out of the holder 2 to extend in a direction perpendicular to an alignment direction alongside the first side wall portion 221 and the second side wall portion 222. The linear portion 402 is bent at a substantially right angle near the cylinder portion 21-side end in the recessed portion 220. In FIGS. 11A and 11B, the bent portion, at which the linear portion 402 is bent, is indicated as 400a. The linear portion 402 extends along the alignment direction with the first side wall portion 221 and the second side wall portion 222 in a portion on the side of the protruding piece 401 than the bent portion 400a, and extends along the first inner wall surface 220a in the portion on the tip-side than the bent portion 400a.

In the linear portion 402, a portion on the tip-side than the bent portion 400a is secured to face the inner wall surface 220a of the recessed portion 220 by the adhesive 7. The first inner wall surface 220a is parallel to a leading direction of the linear portion 402 from the holder 2. Here, the leading direction of the linear portion 402 refers to an extending direction of a portion on the tip-side than the bent portion 400a in the case where the portion is straight inside and outside the recessed portion 220.

As shown in FIGS. 10A to 10C, the cover member 3 integrally comprises the flat plate portion 31 and the boss 32, which is a protrusion that protrudes perpendicularly to the plate portion 31. The plate portion 31 is rectangular viewed from the axial direction. The boss 32 is formed with a retainer 320 for retaining the adhesive 7 and an engaging portion 321 for engaging an engaged portion 222a provided on the second side wall portion 222.

The engaged portion 222a is a depression recessed from the second inner wall surface 220b. The engaging portion 321 is a protrusion that protrudes from the second side wall portion 222-side than the plate portion 31 in axial view. The position of the cover member 3 relative to the holder 2 in the radial direction of the cylinder portion 21 is defined by the engaging portion 321 of the cover member 3 engaging the engaged portion 222a of the protrusion 22 of the holder 2.

In FIG. 11A, the contour of the boss 32 on the bottom side of the recessed portion 220 than the plate portion 31 is shown as a dashed line. The retainer 320 is a space formed to open toward the first side wall portion 221 when the boss 32 is mated in the recessed portion 220. The boss 32 is shaped to hold the adhesive 7 injected into the retainer 320 at a suitable site for securing the linear portion 402 of the signal line portion 400. The shape of the boss 32 viewed from the axial direction is a U-shape formed to enclose the retainer 320 from three sides, as shown in FIGS. 11A and 13A.

An opening 310 is formed in the plate portion 31 of the cover member 3 for injecting the adhesive 7 before curing into the retainer 320. As shown in FIG. 11A, when the cover member 3 is viewed from the axial direction, the opening 310 is smaller than the retainer 320. The adhesive 7 is a thermosetting epoxy adhesive that cures when heated after being injected into the retainer 320. The adhesive 7 is not limited to thermosetting but may also be light-curing.

The adhesive 7 adheres at least to the inner surface 320a of the retainer 320, the bottom surface 220c of the recessed portion 220, and the linear portion 402 of the flexible substrate 4. This secures the linear portion 402 of the flexible substrate 4 to the holder 2 and the cover member 3. In the present embodiment, the adhesive 7 adheres to one surface 4a of the flexible substrate 4 in the linear portion 402, and the other surface 4b contacts the first inner wall surface 220a of the first side wall portion 221. The adhesive 7 may be interposed between the other surface 4b of the flexible substrate 4 and the first inner wall surface 220a at the linear portion 402.

The first side wall portion 221 has a first notch 224 that holds one end of the plate portion 31 of the cover member 3 in the alignment direction of the first side wall portion 221 and the second side wall portion 222. The second side wall portion 222 has a second notch 225 that holds the other end of the plate portion 31 of the cover member 3 in the alignment direction of the first side wall portion 221 and the second side wall portion 222. The first notch 224 has a facing surface 224a facing the one end surface 31a of the plate portion 31, and the second notch 225 has a facing surface 225a facing the other end surface 31b of the plate portion 31. The back surface 31c, which is the boss 32 side-surface of the plate portion 31, is supported by a support surface 224b of the first notch 224 and a support surface 225b of the second notch 225. The support surfaces 224b, 225b are planar surfaces oriented axially.

As shown in FIG. 14, in the alignment direction of the first side wall portion 221 and the second side wall portion 222 (horizontal direction in FIG. 14), a distance D₁ between a first side wall portion 221-side end surface 32a and the one end surface 31a of the plate portion 31 in the boss 32 is greater than a distance D₃ that is a total of a distance D₂ between the facing surface 224a of the first notch 224 and the first inner wall surface 220a in the same direction and a thickness T of the flexible substrate 4. This creates a gap S between the end surface 32a of the boss 32 and the linear portion 402 of the flexible substrate 4, so that the linear portion 402 of the flexible substrate 4 is not pressed against the boss 32. The adhesive 7 before curing enters this gap S and the bonding strength of the linear portion 402 is increased.

Since the linear portion 402 of the flexible substrate 4 is led out of the holder 2, there is no need to connect the flexible substrate 4 to a cable inside the holder 2, which allows the magnetostrictive torque sensor 1 to be made smaller. This makes installing the magnetostrictive torque sensor 1 easier, even when the installation space around the rotating shaft 9 is small. Since the linear portion 402 of the flexible substrate 4 is fixed to the protrusion 22 of the holder 2, even if the linear portion 402 is pulled by external force, the force is not transmitted to the detection portion 40 of the flexible substrate 4, which prevents an interval (i.e., distance) between the detection portion 40 and the outer circumferential surface 21a of the cylinder portion 21 of the holder 2 from fluctuating, thereby reducing deterioration in detection accuracy.

### Second Embodiment

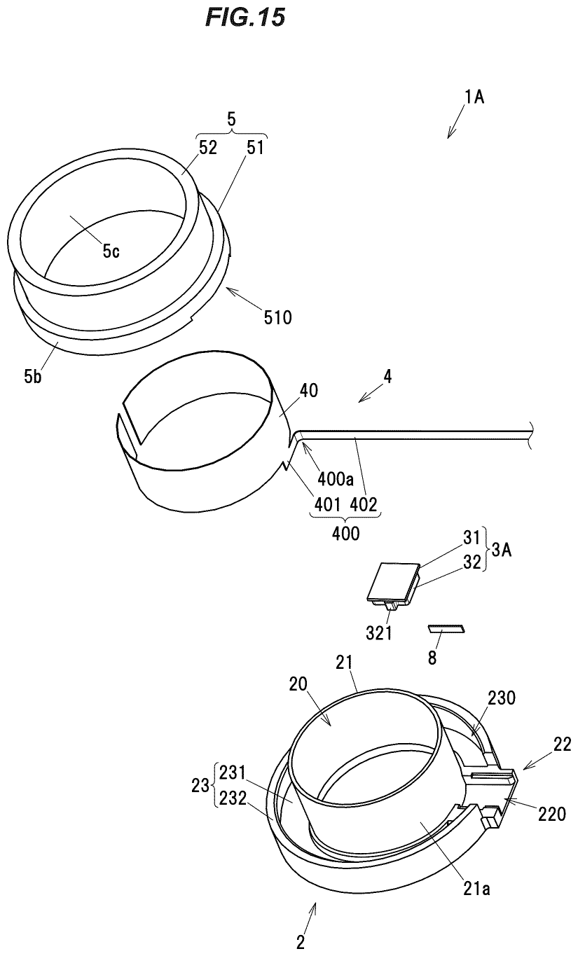

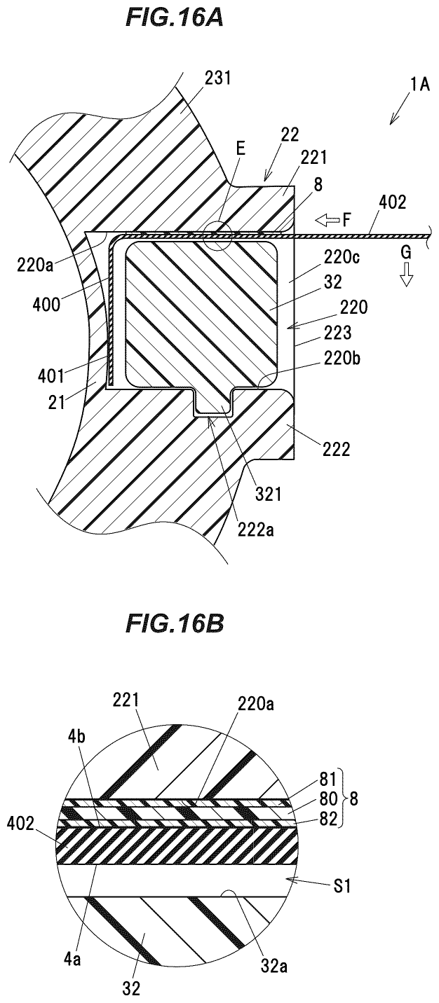

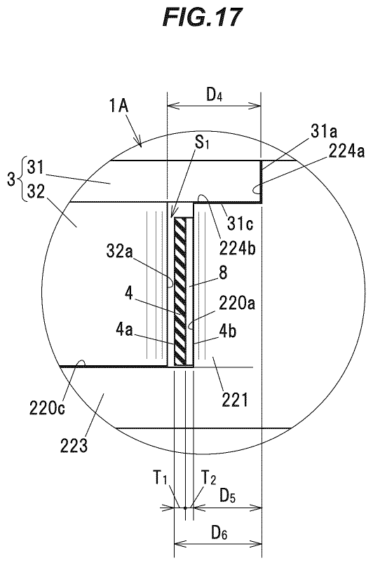

Next, the second embodiment of the invention is described with reference to FIGS. 15 to 17. FIG. 15 is an exploded perspective view of a magnetostrictive torque sensor 1A in the second embodiment. FIG. 16A is a partial cross-sectional view of the magnetostrictive torque sensor 1A in the second embodiment. FIG. 16B is an enlarged view of an E-section in FIG. 16A. FIG. 17 is an enlarged view of the magnetostrictive torque sensor 1A in the second embodiment as viewed from an arrow F-direction in FIG. 16A. In FIGS. 15 to 17, the components are marked with the same characters as those in FIGS. 1 to 14 and duplicated explanations are omitted.

In the first embodiment, the case where the adhesive 7 is used as a fixing member to fix a part in the longitudinal direction of the linear portion 402 of the flexible substrate 4 to the holder 2 is explained. However, an adhesive tape 8 is used as a fixing member in the second embodiment. In the first embodiment, the case where the opening 310 is formed at the plate portion 31 of the cover member 3 and the retainer 320 is formed at the boss 32 is explained. However, in a cover member 3A, no opening 310 is formed at the plate portion 31 and no retainer 320 is formed at the boss 32 in the second embodiment. The configuration of the holder 2 and the flexible substrate 4 in the second embodiment is the same as in the first embodiment.

The adhesive tape 8 is double-sided tape with a first adhesive layer 81 and a second adhesive layer 82 on both sides of a strip-shaped base material 80, as shown in FIG. 16B. The base material 80 is composed of paper, non-woven fabric, or plastic film. The first and second adhesive layers 81, 82 are made of acryl-based, rubber-based, polyurethane-based, or silicone-based adhesive. The first adhesive layer 81 is adhered to the first inner wall surface 220a of the first side wall portion 221 and the second adhesive layer 82 is adhered to the other surface 4b of the flexible substrate 4 in the linear portion 402.

In the linear portion 402 of the flexible substrate 4, a portion secured to the holder 2 by the adhesive tape 8 is covered by the cover member 3A. This prevents external forces from being applied directly to the linear portion 402 of the portion secured to the holder 2 by the adhesive tape 8, and prevents the first adhesive layer 81 of the adhesive tape 8 from peeling off from the first inner wall surface 220a of the first side wall portion 221 and the linear portion 402 of the flexible substrate 4 from the second adhesive layer 82 of the adhesive tape 8.

FIG. 17 shows the dimensional relationship of the various parts of the linear portion 402 of the flexible substrate 4 near the leading part of the linear portion 402 from the holder 2, as described in FIG. 14. As shown in FIG. 17, a distance D₄ between the first side wall portion 221-side end surface 32a and the one end surface 31a of the plate portion 31 at the boss 32 in the alignment direction of the first side wall portion 221 and the second side wall portion 222 (horizontal direction in FIG. 17) is greater than a distance D₆ that is a total of a distance D₅ between the facing surface 224a of the first notch 224 and the first inner wall surface 220a in the same direction, a thickness T₁ of the flexible substrate 4, and a thickness T₂ of the adhesive tape 8. This creates a gap S₁ between the end surface 32a of the boss 32 and the linear portion 402 of the flexible substrate 4, so that the linear portion 402 of the flexible substrate 4 is not compressed by the boss 32. The width of the gap S₁ (the distance between the one surface 4a of the flexible substrate 4 and the end surface 32a of the boss 32) in the thickness direction of the linear portion 402 of the flexible substrate 4 and the adhesive tape 8 is 0.5 times or more and less than 5.0 times the thickness T₁ of the flexible substrate 4.

Due to the formation of the gap S₁, even if the linear portion 402 of the flexible substrate 4 is pulled in an arrow G-direction (direction from the first side wall portion 221 toward the second side wall portion 222) in FIG. 16A, this pulling force between the boss 32 of the cover member 3A and the first side wall portion 221 is converted into a longitudinal direction force on the linear portion 402. This prevents the first adhesive layer 81 of the adhesive tape 8 from peeling off from the first inner wall surface 220a of the first side wall portion 221 and the linear portion 402 from the second adhesive layer 82 of the adhesive tape 8.

When assembling the magnetostrictive torque sensor 1A, the adhesive tape 8 is used to attach the linear portion 402 of the flexible substrate 4 to the first side wall portion 221 of the holder 2, and then the cover member 3A is assembled to the holder 2. When attaching the linear portion 402 of the flexible substrate 4 with the adhesive tape 8, the linear portion 402 and the adhesive tape 8 are pressed against the first side wall portion 221 with fingers or a tool. Since the holder 2 has the recessed portion 220, the space of the recessed portion 220 can be used as a work space to facilitate this operation.

While the adhesive tape 8 is a double-sided tape, an adhesive tape (single-sided tape) with an adhesive layer on only one side of the base material may be used as a fixing member to secure a part in the longitudinal direction of the linear portion 402 of the flexible substrate 4 to the holder 2. In this case, an adhesive tape wider than the width directional dimension of the linear portion 402 may be used. The adhesive tape may be applied to the one surface 4a of the linear portion 402 and the parts of the adhesive tape corresponding to both edges in the width direction of the linear portion 402 may be attached to the holder 2.

### SUMMARY OF THE EMBODIMENTS

Technical ideas understood from the embodiments will be described below citing the reference signs, etc., used for the embodiments. However, each reference sign, etc., described below is not intended to limit the constituent elements in the claims to the members, etc., specifically described in the embodiments.

According to the first feature, a magnetostrictive torque sensor 1, 1A, which is attached around a rotating shaft 9 exhibiting a magnetostrictive effect and detects torque transmitted by the rotating shaft 9, comprises: a holder 2 comprising a cylinder portion 21 with a hollow cavity 20 in a center through which the rotating shaft 9 is inserted and a protrusion 22 provided to protrude radially outward from the cylinder portion 21; and a flexible substrate 4 that comprises a detection portion 40 on which a coil group 4A to 4D comprising a combination of a plurality of detection coils 410 to 419, 420 to 429, 430 to 439, 440 to 449 aligned in a predetermined direction is formed by a wiring pattern, and a signal line portion 400 on which a plurality of signal lines 491 to 494 electrically connecting the coil group 4A to 4D to an external device 6 are formed by a wiring pattern, wherein the detection portion 40 is wrapped around an outer circumference of the cylinder portion 21 of the holder 2, a part in a longitudinal direction of the signal line portion 400 is fixed to the protrusion 22 of the holder 2 by a fixing member (adhesive 7, adhesive tape 8), and a tip end side portion of the signal line portion 400 than the fixed portion is led out of the holder 2.

According to the second feature, in the magnetostrictive torque sensor 1, 1A as described by the first feature, the fixing member 7, 8 is an adhesive or an adhesive tape.

According to the third feature, in the magnetostrictive torque sensor 1, 1A as described by the first or second feature, the detection portion 40 has a rectangular shape with a long-side direction coincident with an alignment direction of the plurality of detection coils 410 to 419, 420 to 429, 430 to 439, 440 to 449, the signal line portion 400 comprises a protruding piece 401 protruding from the detection portion 40 in a direction perpendicular to the long-side direction and a linear portion 402 extending from the protruding piece 401 in the long-side direction, and a portion in a longitudinal direction of the linear portion 402 is fixed to the protrusion 22 of the holder 2 by the fixing member 7, 8.

According to the fourth feature, in the magnetostrictive torque sensor 1, 1A as described by the third feature, the protrusion 22 of the holder 2 is formed with a recessed portion 220 that accommodates a part of the linear portion 402, the recessed portion 220 is recessed in a radial direction of the cylinder portion 21, wherein the linear portion 402 is bent inside the recessed portion 220 and is led out of the holder 2 to extend in a direction perpendicular to a circumferential direction of the cylinder portion 21, and wherein the linear portion 402 is fixed to face an inner wall surface 220a of the recessed portion 220 by the fixing member 7, 8.

According to the fifth feature, in the magnetostrictive torque sensor 1, 1A as described by the fourth feature, the inner wall surface 220a to which the linear portion 402 is fixed by the fixing member 7, 8 is parallel to a leading direction of the linear portion 402 from the holder 2.

According to the sixth feature, the magnetostrictive torque sensor 1, 1A as described by the fourth feature further comprises a cover member 3, 3A comprising a boss 32 configured to mate the recessed portion 220.

According to the seventh feature, in the magnetostrictive torque sensor 1 as described by the sixth feature, the fixing member is an adhesive 7, wherein the cover member 3 is formed with a retainer 320 that retains the adhesive 7.

According to the eighth feature, in the magnetostrictive torque sensor 1A as described by the sixth feature, the fixing member is an adhesive tape 8, wherein a portion of the linear portion 402 fixed by the adhesive tape 8 is covered with the cover member 3A.

Although the embodiment and modified examples of the invention have been described, the invention according to claims is not to be limited to the embodiment and modified examples described above. Further, please note that not all combinations of the features described in the embodiment and modified examples are necessary to solve the problem of the invention.

1. A magnetostrictive torque sensor configured to be attached around a rotating shaft exhibiting a magnetostrictive effect and detects torque transmitted by the rotating shaft, comprising:
a holder comprising a cylinder portion with a hollow cavity in a center through which the rotating shaft is inserted and a protrusion provided to protrude radially outward from the cylinder portion; and
a flexible substrate that comprises a detection portion on which a coil group comprising a combination of a plurality of detection coils aligned in a predetermined direction is formed by a wiring pattern, and a signal line portion on which a plurality of signal lines electrically connecting the coil group to an external device are formed by a wiring pattern,
wherein the detection portion is wrapped around an outer circumference of the cylinder portion of the holder, and
wherein a part in a longitudinal direction of the signal line portion is fixed to the protrusion of the holder by a fixing member, and a tip end-side portion of the signal line portion than the fixed portion is led out of the holder.

2. The magnetostrictive torque sensor, according to claim 1, wherein the fixing member is an adhesive or an adhesive tape.

3. The magnetostrictive torque sensor, according to claim 1, wherein the detection portion has a rectangular shape with a long-side direction coincident with an alignment direction of the plurality of detection coils,
wherein the signal line portion comprises a protruding piece protruding from the detection portion in a direction perpendicular to the long-side direction and a linear portion extending from the protruding piece in the long-side direction, and
wherein a portion in a longitudinal direction of the linear portion is fixed to the protrusion of the holder by the fixing member.

4. The magnetostrictive torque sensor, according to claim 3, wherein the protrusion of the holder is formed with a recessed portion that accommodates a part of the linear portion, wherein the recessed portion is recessed in a radial direction of the cylinder portion, wherein the linear portion is bent inside the recessed portion and is led out of the holder to extend in a direction perpendicular to a circumferential direction of the cylinder portion, and
wherein the linear portion is fixed to face an inner wall surface of the recessed portion by the fixing member.

5. The magnetostrictive torque sensor, according to claim 4, wherein the inner wall surface to which the linear portion is fixed by the fixing member, is parallel to a leading direction of the linear portion from the holder.

6. The magnetostrictive torque sensor, according to claim 4, further comprising:
a cover member comprising a boss configured to mate the recessed portion.

7. The magnetostrictive torque sensor, according to claim 6, wherein the fixing member is an adhesive, and
wherein the cover member is formed with a retainer that retains the adhesive.

8. The magnetostrictive torque sensor, according to claim 6, wherein the fixing member is an adhesive tape, and
wherein a portion of the linear portion fixed by the adhesive tape is covered with the cover member.
